(19) United States
(12) Patent Application Publication
(10) Pub. No.: US 2012/0255942 A1
(43) Pub. Date: Oct. 11, 2012

(54) Traffic Light Heater

(75) Inventor: Brian Vodvarka, Wisconsin Dells, WI (US)

(73) Assignee: HANKSCRAFT INC., Reedsburg, WI (US)

(21) Appl. No.: 13/434,130

(22) Filed: Mar. 29, 2012

Related U.S. Application Data
(60) Provisional application No. 61/472,379, filed on Apr. 6, 2011.

(51) Int. Cl. H05B 3/02

(52) U.S. Cl. 219/209

(57) ABSTRACT

A circuit for controlling a heater element coupled to a traffic signal light includes: a thermistor positioned at an exterior of a lens of the traffic signal light, a resistance of the thermistor decreasing as a temperature of the lens increases; and a comparator positioned at an interior of the lens, the comparator being configured to monitor a feedback signal from the thermistor and to compare the feedback signal to a reference signal, and to turn power supplied to the heater element on and off based on the comparison.

### RELATED APPLICATION

This application claims the benefit of U.S. patent application Ser. No. 61/472,379 filed on Apr. 6, 2011, the entirety of which is hereby incorporated by reference.

### BACKGROUND

Traffic signals are used to govern the flow of traffic along roadways. During snowstorms and other inclement weather, snow and/or ice can accumulate on the traffic signals, thereby impacting the ability for motorists to see the signals. This problem is more pronounced with newer light technologies, such as light-emitting diode (LED) lights, which do not generate as much heat as traditional incandescent lights and therefore do not function to melt accumulating snow and ice as efficiently.

### SUMMARY

In one aspect, a circuit for controlling a heater element coupled to a traffic signal light includes: a thermistor positioned at an exterior of a lens of the traffic signal light, a resistance of the thermistor decreasing as a temperature of the lens increases; and a comparator positioned at an interior of the lens, the comparator being configured to monitor a feedback signal from the thermistor and to compare the feedback signal to a reference signal, and to turn power supplied to the heater element on and off based on the comparison.

### DESCRIPTION OF THE FIGURES

FIG. 1 shows a block diagram of one section of an example quad comparator controller of a proposed heater control circuit.

FIG. 2 shows a block diagram of an NTC thermistor, a lens, and a comparator of the heater control circuit.

FIG. 3 is a simplified block diagram of an FET output connected to a lens heater through a DC power supply.

FIG. 4 shows a simplified block diagram of a power supply connected to the comparator and powered by an AC input.

FIG. 5 is the backside view of the lens including an example heater element.

FIG. 6 is the side view of the lens showing the heater element, lens, and thermistor.

FIG. 7 shows a schematic of a single section of the heater control circuit.

### DETAILED DESCRIPTION

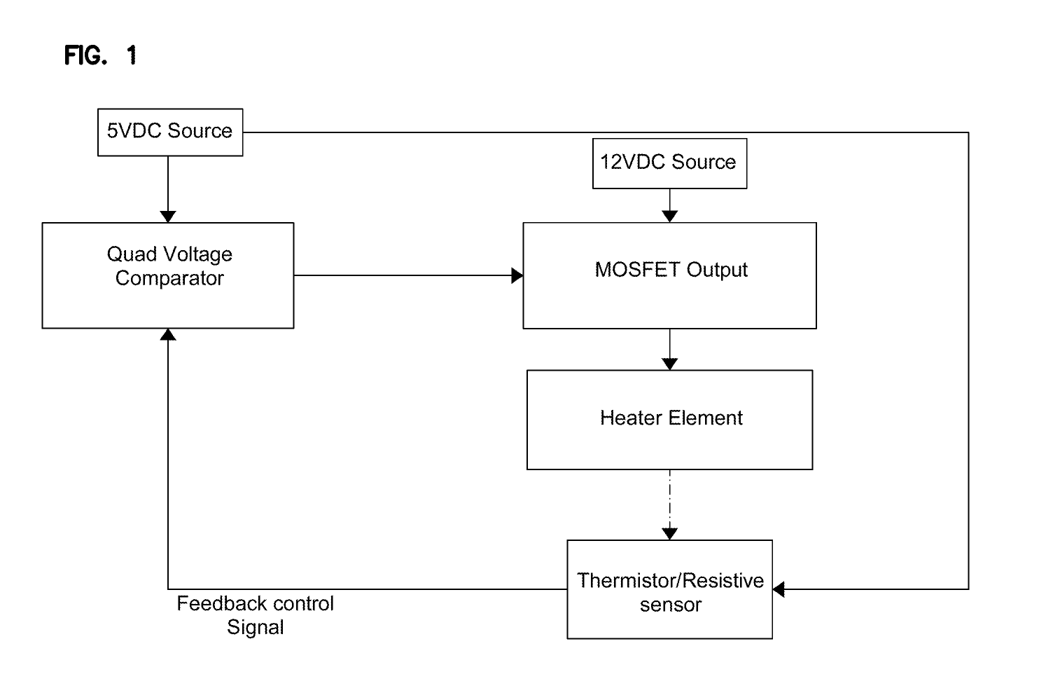

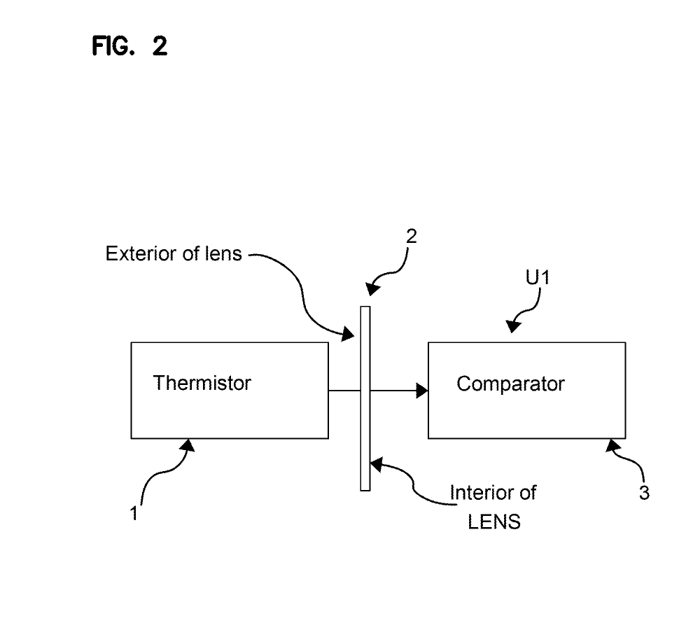

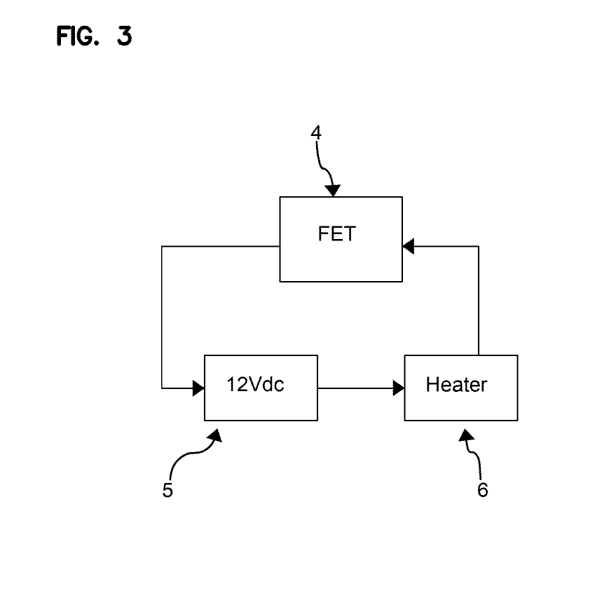

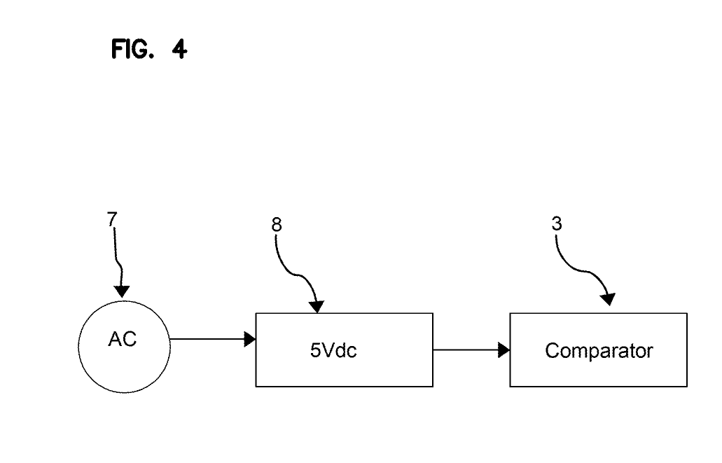

The systems and methods described herein are directed at a heater control circuit that is configured to minimize the buildup of snow and/or ice on traffic signals. FIGS. 1-7 illustrate various aspects of the example heater control circuit.

FIGS. 1-4 illustrates one section of a quad comparator controller of the proposed heater control circuit. The quad comparator 3 is selected so that four separate lens heaters 6 are controlled with one single IC chip. Although a variety of quad OP-Amp comparators could be used, the LM324 is chosen for this particular design. The feedback control signal is developed through a voltage divider network using an NTC thermistor 1 and a fixed resistance. In this configuration, the control signal amplitude changes with lens 2 temperature. Other configurations can be used.

In operation, a 5 VDC power supply 8 is driven using an AC source 7. The 5 VDC power supply is applied to the power pins of the comparator. The comparator monitors the feedback signal which is compared to a reference signal of constant value. The feedback signal level changes according to temperature; this is accomplished through a voltage divider comprised of the thermistor and a fixed resistance in series with the thermistor. The feedback signal is sampled at the connection of the fixed resistor and the thermistor and fed to the inverting input of the quad comparator. All are powered from the 5 VDC power supply.

The magnitude of the feedback signal is dependent on the temperature of the NTC thermistor. The NTC thermistor has a negative resistance characteristic. This characteristic is used to develop the control signal in conjunction with a fixed resistance value. The colder the thermistor becomes, the higher the resistance will be, and the hotter the thermistor becomes, the lower the resistance will be.

At 32° F., the thermistor resistance is 350K. This is the turn on temperature of the heater control. The voltage divider network is configured to operate based on the 350K of this particular thermistor; any NTC could be used by adjusting the fixed resistances to accommodate the NTC resistance at a specified temperature.

The reference voltage applied to the non-inverting input is 2.5 VDC, which is half the supply voltage. The feedback signal floats above this value and below this value based on temperature, which becomes the turn on and turn off limits of the heater control. Whichever voltage is higher (inverting input or non-inverting input) will determine which input is in control of the circuit. If the reference voltage is higher than the feedback voltage, the circuit will turn on the heater, and if the feedback voltage is higher; then the circuit will turn off the output of the comparator and hence the gate voltage is no longer present at the MOSFET 4, and the heater is effectively switched off.

High side switching is chosen for this application as an effective way to source the heater current. In other designs, the current could be sunk to the proper level.

In some examples, the lens heaters 6 are semi- or completely transparent. Power for the heater elements is supplied through a 12 VDC supply 5, which is switched on and off through the use of the MOSFET IRF510 transistor switch, which is gate triggered from the comparator output.

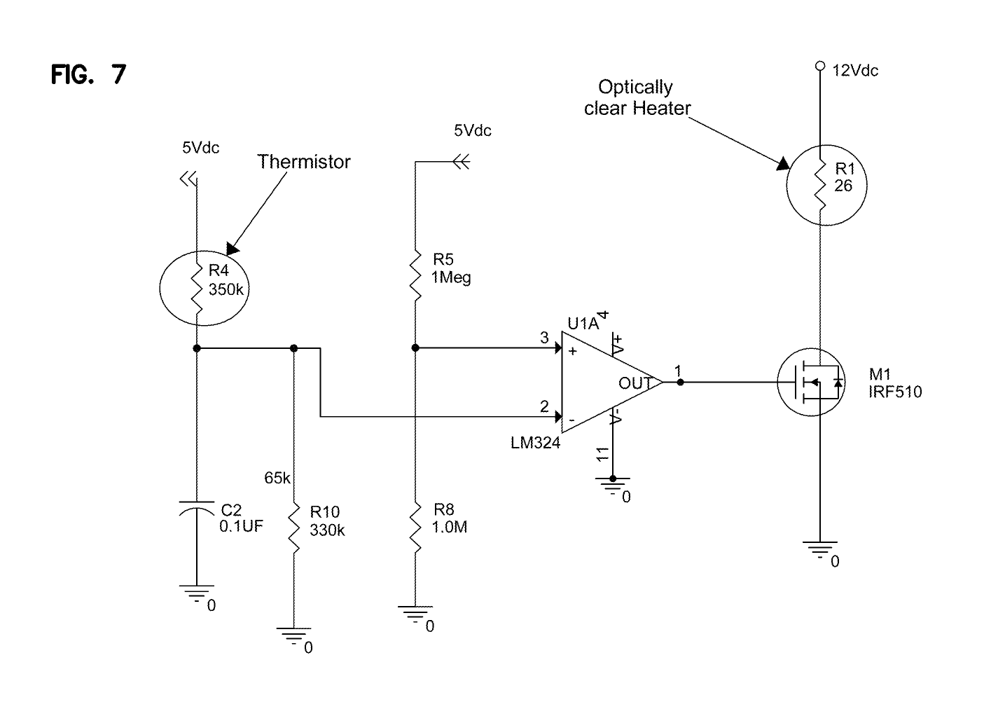

A schematic is shown in FIG. 7 of a single section of the heater control circuit.

R5 and R8 set the reference voltage at 2.5 VDC (50% of the supply voltage). This value is chosen to allow the feedback voltage to swing above and below this point.

R4 and R10 set the feedback voltage which varies above and below the reference voltage due to the resistance characteristics of the thermistor R4 at a given temperature.

C2 is a decoupling capacitor used to filter noise from the supply to keep the circuit from seeing any voltage spikes which could cause false triggering.

R4 is the NTC thermistor used for temperature sensing. R1 is the heater resistance.

The circuit is designed so that when the inverting signal input of the comparator (the feedback signal in this case) is larger than the non-inverting input (the reference signal), the unit will turn off, as now the inverting input is in control of the circuit. This condition will happen when the temperature is near 36° F. As the temperature increases, the thermistor resistance decreases, causing more voltage to appear at the inverting input. This voltage will be in control as long as it is larger than the reference voltage, keeping the unit turned off and power to the heater interrupted.

As the temperature drops to the freezing mark, the resistance of the thermistor begins to rise. This rising resistance causes less voltage to be applied to the inverting input and eventually the inverting input voltage is now lower than the non-inverting input voltage, and the higher reference voltage (non-inverting input) turns the output of the comparator on. In this state, the voltage is once again applied to the heater through the gate drive signal being received from the comparator to the gate of the MOSFET.

This cycle continues indefinitely, as the temperature reaches the freezing mark and as the temperature climbs back around 36° F. A small amount of natural hysteresis is applied due to the internal circuit of the comparator to keep the unit from switching on and off rapidly once the temperature climbs above 32° F. In this case, there is about a 4° F. to 6° F. window from turn on to turn off. More hysteresis can be added by adding a resistance between the output and the non-inverting input of the comparator, if needed.

This circuit is dependent on temperature and the resistance of the NTC and is set to come on at 32° F. and shut off at or near 36° F. The turn off temperature can be changed by the amount of hysteresis employed in the circuit.

The thermistor is mounted to the outside of the lens to monitor the outside lens temperature. This could also be accomplished by monitoring the heater resistance and eliminating the thermistor altogether.

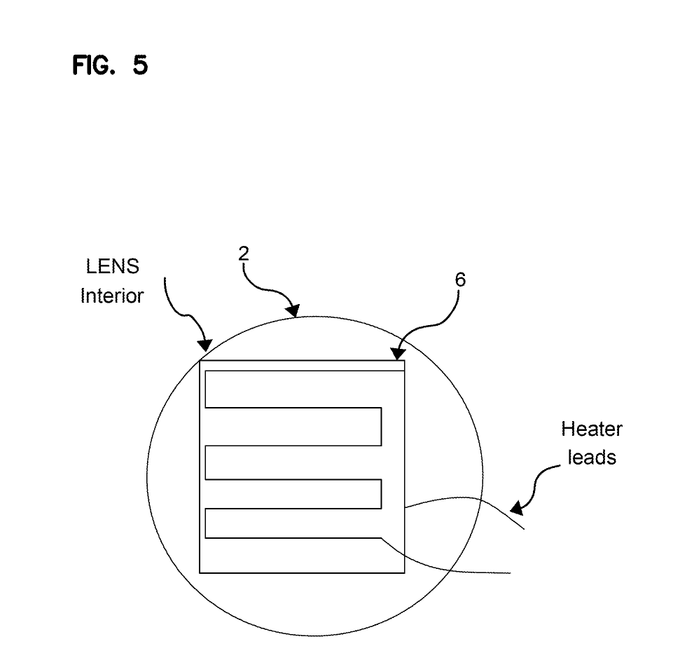

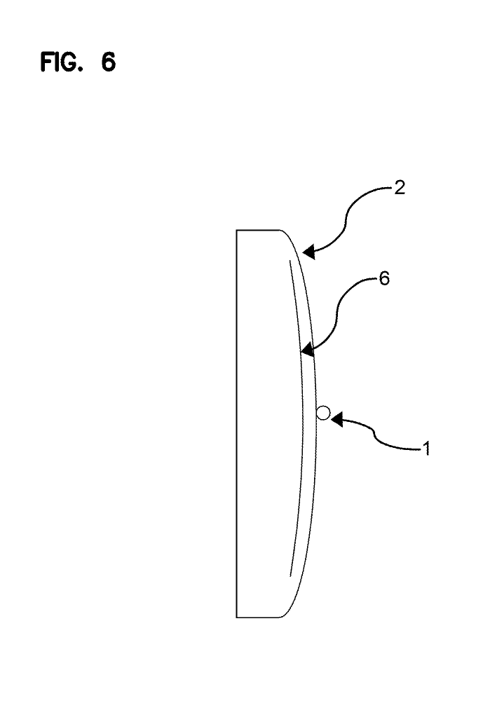

The heater is a wire heater sandwiched between 2 optically clear polyester sheets. See FIGS. 5 and 6. The heater is affixed to the inside of the lens with 3M clear PSA (pressure sensitive adhesive).

AC Isolation is accomplished through the 12 Volt transformer windings and can be enhanced by the use of an opto-coupler. The transformer is isolated up to 1500 VAC between the primary and secondary.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A circuit for controlling a heater element coupled to a traffic signal light, the circuit comprising:
a thermistor positioned at an exterior of a lens of the traffic signal light, a resistance of the thermistor decreasing as a temperature of the lens increases; and
a comparator positioned at an interior of the lens, the comparator being configured to monitor a feedback signal from the thermistor and to compare the feedback signal to a reference signal, and to turn power supplied to the heater element on and off based on the comparison.

2. The circuit of claim 1, wherein the feedback signal is five volts direct current.

3. The circuit of claim 2, wherein the heater element is turned on and off using a MOSFET switch.

4. The circuit of claim 1, wherein the heater element is turned on and off using a MOSFET switch.

5. A traffic signal light, comprising:
a lens,
a heating element coupled to the lens; and
a circuit for controlling the heater element, the circuit including:
a thermistor positioned at an exterior of the lens of the traffic signal light, a resistance of the thermistor decreasing as a temperature of the lens increases; and
a comparator positioned at an interior of the lens, the comparator being configured to monitor a feedback signal from the thermistor and to compare the feedback signal to a reference signal, and to turn power supplied to the heater element on and off based on the comparison.

6. The traffic signal light of claim 5, wherein the feedback signal is five volts direct current.

7. The traffic signal light of claim 6, wherein the heater element is turned on and off using a MOSFET switch.

8. The traffic signal light of claim 5, wherein the heater element is turned on and off using a MOSFET switch.
